(19) United States
(12) Patent Application Publication
(10) Pub. No.: US 2009/0316890 A1
(43) Pub. Date: Dec. 24, 2009

(54) TEXT BASED ANTI-PIRACY SYSTEM AND METHOD FOR DIGITAL CINEMA

(76) Inventor: Mark Alan Schultz, Carmel, IN (US)

Correspondence Address: Robert D. Shedd, Patent Operations;THOMSON Licensing LLC, P.O. Box 5312, Princeton, NJ, 08543-5312, US

(21) Appl. No.: 12/312,666

(22) PCT Filed: Dec. 11, 2006
(86) PCT No.: PCT/US06/46956

§ 371 Date: May 20, 2009

(51) Int. Cl. H04L 9/00; H04N 7/16

(52) U.S. Cl. 380/203

(57) ABSTRACT

A system and method for generating and processing forensic information for digital cinema content in an efficient and cost-effective manner while maintaining the integrity and quality of the digital cinema images. Customized forensic content, which includes hidden anti-camcorder text data, is generated for display with corresponding digital cinema content. Real-time information is incorporated into the customized forensic content. The real-time information includes textual data in hidden form indicating, e.g., at least one of an actual time, date and location pertaining to each actual showing of the digital cinema content. The customized forensic content having real-time information is virtually undetectable in authorized copies yet easily and quickly detectable and decipherable in pirated copies during forensic analysis.

### TECHNICAL FIELD OF THE INVENTION

The present invention generally relates to anti-piracy film security and, more particularly, to a system and method for generating and incorporating forensic information into digital cinema content for anti-piracy purposes.

### BACKGROUND OF THE INVENTION

Many of today's printed films are marked with, e.g., patterns and/or arrangements of special dots, colors, and symbols to create a unique identification for each specific film print that is being shown in a movie theatre. These marks are captured by any device (e.g., video camcorders) which may record the marked films. Film studios can analyze pirated videos to recover any markings found in the video content. The marks are then cross-referenced with a table of stored codes to determine which theatre was sent the particular pirated film print and an investigation and appropriate action may be conducted.

Forensic information may be added to Digital Cinema in the form of watermarks. The watermarks, while discernible on a pirated video, are usually subtle so as to not distract from the movie while an audience is watching the movie play on a screen in a theater. The watermarks can be extracted from a pirated video by special signal processing which normally reveals a series of codes that can be translated into the information a particular studio selected to encrypt in the watermark.

The above techniques, however, require a significant amount of labor and processing to recover any forensic information. Many of the systems require real time searches to locate any markings and further special processing to recover the marks, which can be an extremely costly process. In situations where a large number of pirated films appear in the markets, the cost to recover and analyze the forensic information for every pirated film often becomes prohibitively enormous, forcing many studios to cease work on forensic recovery and analysis due to lack of funds.

Until digital cinema, it was difficult to perform sophisticated forensic marking on movies without undesirable side effects, such as degradation of the actual movie content or interference with the visual quality of the movie due to ineffective or poor concealment of the markings. Furthermore, recovery of the markings during the forensic analysis process remained very expensive.

Other techniques exist for printing and encoding films, e.g., with simpler binary codes in the data, or rendering pirated copies to display simple text such as “Illegal Copy,” “Pirate,” or some other simple message. While these techniques may initially be lower in cost, they nevertheless have a very high recovery cost in terms of actual manual labor required during the forensic analysis process, as well as overhead due to data entry and record keeping.

Accordingly, an efficient and effective system and method for marking digital cinema for detecting and tracing unauthorized pirated copies with optimized efficiency and cost-effectiveness would be highly desirable.

### SUMMARY

A method, apparatus and system in accordance with various embodiments of the present principles address the deficiencies of the prior art by providing a system and method for incorporating forensic information in digital cinema so as to render any unauthorized copies of same quickly, easily and readily identifiable for the purposes of forensic identification and analysis and tracing of the film's location, theater and time of showing, etc.

Using standards for Digital Cinema, additional controls are provided according to one aspect of the present principles so as to enable the incorporation of Anti-Camcorder for Digital Cinema (ACDC) data into Digital Cinema (DC) movie content in a manner which is virtually undetectable to an observer of authorized content (e.g., at a theater showing) yet immediately and effectively provides detailed forensic information (e.g., theatre location, date, time that the movie was captured, etc.) on a pirated (e.g., ‘camcordered’) copy of the movie to any observer of same. Advantageously, expedited identification and tracing of illegal copies is facilitated and further piracy can be curtailed quickly and at low cost.

The incorporation/addition of ACDC forensic information into standard DC content may be performed by a service provider (e.g., a movie studio, post-production house, etc.). Advantageously, each studio may control and customize the amount, rate, type of forensic information to be added as well as the technique desired to place the forensic information on the screen.

According to one aspect of the present principles, ACDC forensic information may include real-time information with regards to specific individual projection devices used to display each movie. The incorporated ACDC information is ‘hidden,’ that is, undetectable to the human eye in authorized copies/showings of a movie, yet immediately visible and conveys information about the movie on a pirated copy (e.g., an illegally recorded copy obtained via a camcorder device or other copy obtained by a sampling system). To any observer of a pirated copy, the ACDC content is immediately detectable and directly reveals valuable and useful forensic data, including the theater location, date and time the movie was captured, etc., without requiring specialized and complicated forensic analysis techniques.

Accordingly, a system and method according to one aspect of the present principles improves efficiency in piracy detection and control by displaying easily analyzed and useful forensic information directly in the movie/video images that is fully visible to a viewer of pirated copies; yet effectively hidden on authorized copies. It is noted that other types of forensic content, such as other types of hidden forensic content (e.g., employing techniques involving marking with special dots, symbols, etc., which are intended to be virtually invisible/undetectable to the ordinary viewer on either authorized or pirated copies) may be incorporated in addition to the forensic information applied according to one aspect of the present principles.

The location/time relating to where and when the ACDC information is to be displayed in a movie can be brought in as an auxiliary stream, e.g., as another language sub-title, or in the timed-text, etc., and rendered onto the movie picture content by an overlay. The time, font, color, and position can be controlled by, e.g., an alpha channel datapath utilizing, e.g., standard auxiliary information techniques. The actual text displayed may be provided by the digital cinema content and/or by a projection device's internal location/data settings.

A service provider (e.g., studio or post-production house) may provide services for analyzing and optimizing ACDC algorithms or the visible forensic algorithms according to the present principles for delivery of, e.g., special video at specific locations/times on the screen. Such data may then be added in an alpha channel as part of the digital cinema content package deliverable. Once the content is delivered to the theater, software at the local theater may either use or discard the information depending on, e.g., the licensing arrangement with the studio. Different levels of forensic content could be licensed for different levels of content protection. For example, a movie screening or premiere might be accorded a high level of forensic protection while an older movie may have the protection reduced or even turned off.

In one aspect, a method for providing forensic information for digital cinema content is provided comprising the steps of generating customized forensic content configured for display with said digital cinema content, the forensic content comprising hidden anti-camcorder text data, and incorporating real-time information in hidden form into said forensic content.

In another aspect, a system for generating forensic information for digital cinema content is provided comprising an analyzer module configured to analyze digital cinema content for generating customized forensic content, the forensic content comprising hidden anti-camcorder text data, a local encryption module configured to encrypt said forensic content, and a formatting module configured to format said encrypted forensic content as an auxiliary data stream.

In yet another aspect, a system for processing forensic information for digital cinema content is provided comprising a projection device configured to process and display at least digital cinema content and customized forensic content, wherein said customized forensic content comprises hidden anti-camcorder text data. The projection device further comprises a security decryption module for decrypting and verifying the digital cinema and customized forensic content, an extraction module configured to extract the customized forensic content, a local decryption module for decrypting the customized forensic content, a controller for incorporating real-time information into the customized forensic content, and an anti-camcorder algorithm module for incorporating the customized forensic content including the real-time information into the digital cinema content.

In yet another aspect, a system for generating and processing forensic information for digital cinema content is provided comprising an analyzer module configured to analyze digital cinema content for generating customized forensic content, the customized forensic content comprising hidden anti-camcorder text data, and a projection device configured to process and display at least the digital cinema content and said customized forensic content. The projection device further comprises a security decryption module for decrypting and verifying the digital cinema and customized forensic content, and a controller for incorporating real-time information into the customized forensic content.

These, and other aspects, features and advantages of the present invention will be described or become apparent from the following detailed description of the preferred embodiments, which is to be read in connection with the accompanying drawings.

### BRIEF DESCRIPTION OF THE DRAWINGS

In the drawings, wherein like reference numerals denote similar elements throughout the views:

FIG. 1 is an exemplary system diagram for preparing forensic content for digital cinema according to an aspect of the present invention;

FIG. 2 is an exemplary system diagram for processing forensic content for display according to an aspect of the present invention;

FIG. 3 is an exemplary method flow for preparing forensic data according to an aspect of the present invention;

FIG. 4 is an exemplary method flow for processing forensic data for display according to an aspect of the present invention;

FIG. 5 depicts an exemplary theater and projection system setup including a pirate camera for illustrative purposes;

FIG. 6 illustrates an exemplary depiction of an image including forensic content according to an aspect of the present invention;

FIG. 7 illustrates an exemplary depiction of an image including forensic content according to an aspect of the present invention;

FIG. 8 illustrates an exemplary depiction of an image including forensic content according to an aspect of the present invention;

FIG. 9 illustrates an exemplary depiction of an image including forensic content according to an aspect of the present invention;

FIG. 10 illustrates an exemplary depiction of an image including forensic content according to an aspect of the present invention;

FIG. 11 illustrates an exemplary depiction of an image including forensic content according to an aspect of the present invention; and

FIG. 12 illustrates an exemplary depiction of an image including forensic content according to an aspect of the present invention.

It should be understood that the drawings are for purposes of illustrating the concepts of the invention and are not necessarily the only possible configuration for illustrating the invention.

### DETAILED DESCRIPTION OF PREFERRED EMBODIMENTS

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

Advantageously, according to one aspect of the present principles, the generation and incorporation of forensic content including real-time information in hidden form (e.g., is virtually undetectable in authorized copies, yet readily and easily detectable and decipherable in unauthorized copies) into digital cinema is heretofore provided. Controls may be provided and used in conjunction with Digital Cinema standards to load forensic content and supply information to determine, e.g., where, when, and in what form forensic information is incorporated with movie image content. Forensic data may be incorporated which is easily detectable and instantaneously reveals valuable forensic information in pirated copies.

Digital Cinema includes additional data paths in the form of, e.g., alpha-channel data, metadata, timed-text, and control information. According to one aspect of the present principles, the additional data paths can be used to modify the normal Digital Cinema picture content to add, e.g., real-time forensic information to the movie which may be customized and is unique to each movie and its showing. Such added forensic content is undetectable in authorized copies so as not to distract or interfere with the movie content. Forensic content (ACDC information) including real-time information generated and incorporated according to one aspect of the present principles is preferably in ‘hidden’ form, i.e., invisible to an audience viewing an authorized copy (e.g., a showing in a theater) yet immediately visible in a pirated copy (e.g., a copy obtained via unauthorized recording by a camcorder or other sampling system). Such ACDC information may comprise, e.g., text matter configured to display, for example, the actual location, time and date that the movie was being shown at a theater, an offset time that adds some simple coding to the content, and/or any set of numbers/letters that may be coded to convey data.

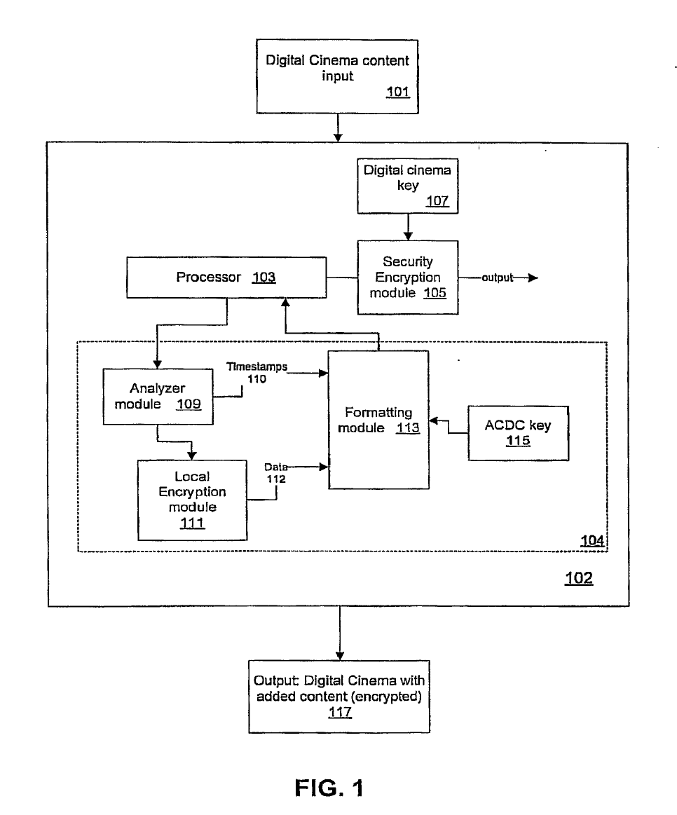

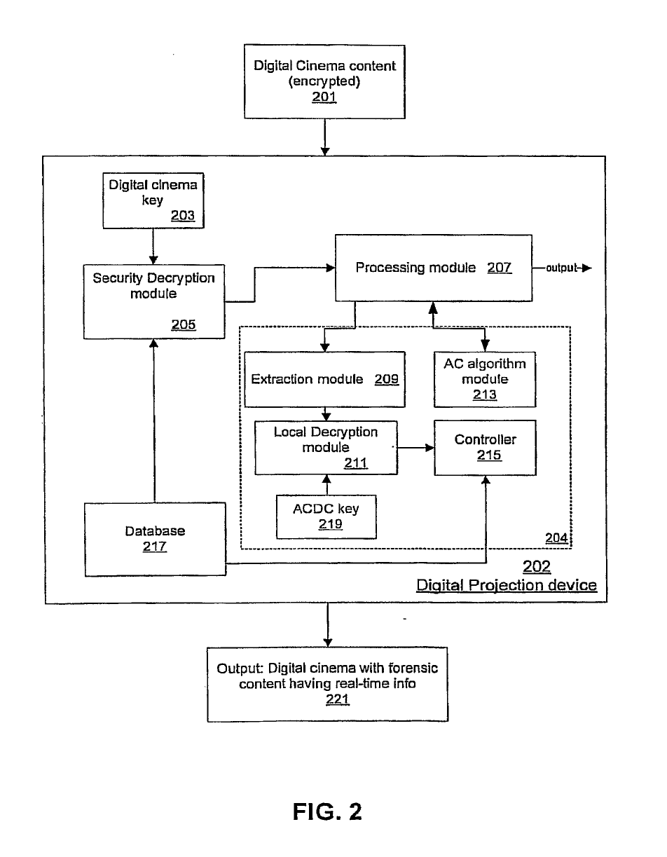

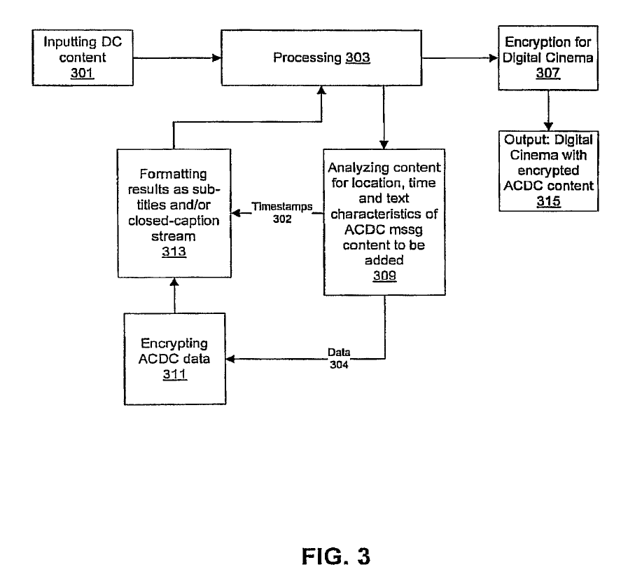

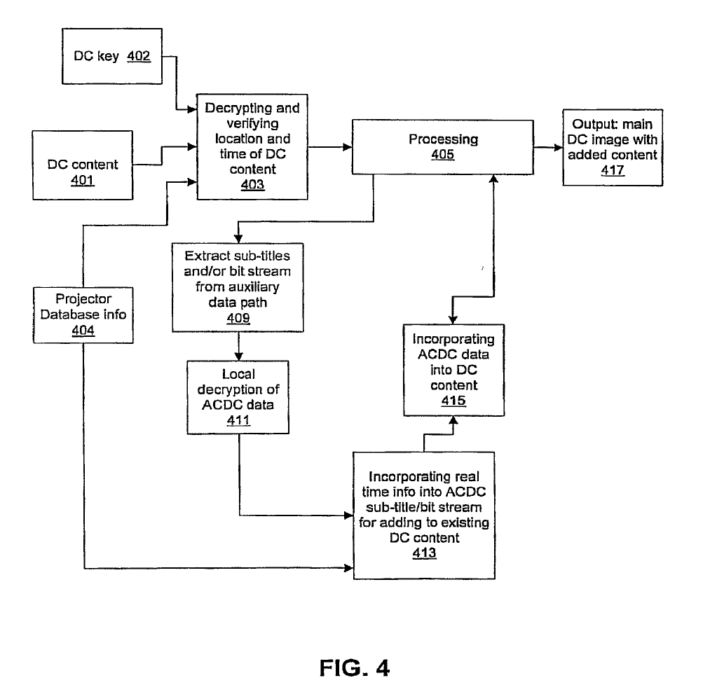

Referring now to the Figures, exemplary system components and exemplary layouts of same according to embodiments of the present principles are shown in FIGS. 1 and 2. System components herein described with regards to FIG. 1 may comprise components of a Digital Cinema (DC) processing system. System components of FIG. 2 may comprise components of a digital projection system. FIGS. 3 and 4 are exemplary method flows for FIGS. 1 and 2, respectively, and will be described in conjunction with same.

A DC processing environment 102 (e.g., at a forensic service provider) comprises a secure environment for receiving, processing and encoding Digital Cinema content 101 and may include a processor 103, a security encryption module 105 and a digital cinema key 107. Module system 104 is provided and configured to perform forensic formatting and processing according to one aspect of the present principles, preferably in addition to normal DC processing (e.g., for the main DC content). Module system 104 includes an analyzer module 109 for performing an analysis of the DC content 101 for determining location, time and text characteristics for insertion/addition of Anti-Camcorder Digital Cinema (“ACDC”) message content (i.e., customized forensic content). The term “Anti-Camcorder Digital Cinema content” as used herein refers to any content directed for use/incorporation with Digital Cinema to deter/trace piracy, whether piracy occurs via a camcorder or any other sampling/recording device.

A local encryption module 111 performs local encryption of ACDC data to be incorporated into the DC content, and the encrypted ACDC content 112 is provided to formatting module 113. In one embodiment as shown in FIGS. 1 and 3, timestamps 110 are not encrypted and are sent directly to the formatting module 113; however for enhanced security, encryption of the timestamps as well may be contemplated. Alternatively, significant amounts of blank data may be added at other timestamps to assist, e.g., in masking the location of the added forensic data.

The formatting module 113 formats the resultant encrypted forensic data/timestamps in/as an auxiliary data stream, e.g., as sub-titles, timed text (e.g., text which uses time stamps to become active and visible), closed-caption streams, etc., and a corresponding ACDC decryption key 115 is created for same. For example, the ACDC content may be carried on an alpha channel, which is an overlay module used to key subtitles and/or open captions into the main image(s) of the digital cinema stream. Thus, the alpha channel is one exemplary datapath which may be used to carry data (e.g., forensic data) in addition to the actual core DC movie content. The time, font, color, position, etc., may be controlled by the alpha channel using e.g., standard auxiliary information techniques.

The ACDC key is a decryption key established for the forensic data/services provided according to one aspect of the present principles. Preferably, the ACDC key is generated to protect the forensic content (ACDC content) and/or a system that generates/processes the forensic content (e.g., a digital projector).

The formatted forensic content is sent to processor 103, which compresses/encrypts the main Digital Cinema content and the forensic content via Security Encryption module 105. A Digital Cinema decryption key 107 is created for the main DC content and is preferably unique to each project/movie. The Digital Cinema key 107 protects the content of the movie studios and is the main decryption key used for the DC movie content. Output 117 may comprise encrypted Digital Cinema content with added encrypted ACDC forensic content, as well as the corresponding decryption keys (e.g., DC and ACDC keys).

Advantageously, a DC processing system according to one aspect of the present principles enables a service provider to control, e.g., the amount of forensic information, the rate of forensic information as well as the anti-camcorder technique chosen to place forensic information in digital cinema content. Thus, different versions of movies with various levels of forensic content could be produced, allowing studios to tailor the level of anti-camcorder processing according to the actual theater the movie is to be shown. For example, theaters which have a history of frequent occurrences of piracy could be targeted to receive digital cinema content with a much higher level of ACDC processing than theaters with no record of piracy violations. Accordingly, e.g., theaters with better piracy preventative measures could receive movies with a higher picture quality than theaters with reputations for frequent piracy occurrences.

FIG. 3 depicts exemplary method steps corresponding to the system of FIG. 1, namely illustrating inputting (step 301) DC content and processing (step 303) of same, which includes analyzing the DC content (step 309) for determining and customizing, e.g., where, when and what type of characteristics are desired for ACDC message content to be incorporated with the DC content according to one aspect of the present principles.

Preferably, ACDC content generated according to one-aspect of the present principles comprises textual matter conveying direct information regarding each movie showing, e.g., the time/date of showing, theater location, screen number, etc. In addition or alternatively, the textual matter itself may be encoded to indicate the time/date/location, etc. (e.g., a series of numbers/letters may be used to correspond to a certain time(s) and/or address). Such textual information is preferably placed directly in the movie images and are immediately and plainly viewable on pirated copies. Advantageously, valuable information about the pirated copy's origins is immediately acquired without time-consuming and costly forensic deciphering and analysis.

In the exemplary depiction here, only the ACDC data 304 is encrypted (step 311), while timestamps 302 are left in unencrypted form. The encrypted ACDC data may be formatted (step 313) as e.g., subtitles, closed-caption streams, etc. and sent for processing (step 303). In this example, the timestamps 302 are sent directly for formatting, e.g., for the sake of convenience so as to enable a user to determine locations in a video stream without requiring decryption of all tracks/data first. Processed DC as well as ACDC data may be encrypted (step 307) e.g., as per the Advanced Encryption Standard (AES) protocol, and Digital Cinema with ACDC forensic content incorporated therein according to one aspect of the present principles may be output (step 315).

It is noted that any Anti-Camcorder technique for incorporating ‘hidden’ AC content into an image, including real-time information in ‘hidden form’, i.e., wherein the AC content/real-time text information will be captured by a sampling device (e.g., a camcorder) and visible in pirated copies yet remains virtually invisible to the human eye in authorized copies, may be utilized to generate and incorporate the ACDC content/real-time information in hidden form according to one aspect of the present principles. Examples of anti-camcorder techniques which can be used for rendering the AC content in hidden form are generally well known and include infrared (IR) systems that blast IR energy onto the screen to upset the focus and captured image of the camcorder. If the IR is modulated, images can be formed onto the screen that the audience will not see but the camcorder will ‘see.’ In addition, frame modulation that greatly increases the number of frames, such as 150 fps, being projected from the original 24 fps movie content can be used. E.g., small changes in one color direction to one frame can be introduced and similar small changes in the complement color to the next frame can be introduced, and the process repeated. The projected image will look normal to the human eye due to averaging of the frames; however a sampling device such as a camcorder will not achieve the same type of averaging and will capture the small changes in the video over time. Multi-primary systems can also be used to foil camcorders by providing content that doesn't map well into an imager due to the frequency response of the imager. Multi-primary systems can contain more than three primaries so that the camera is always lacking some of the energy needed to fully recover the image.

FIG. 2 is an exemplary system diagram configured for processing encrypted forensic data for digital cinema. FIG. 4 is a flow diagram of an exemplary method for processing forensic data for display according to one aspect of the present principles.

In one exemplary embodiment, a digital projection device 202 is provided including a processing module 207 and a security decryption module 205 configured for receiving, decrypting and processing encrypted Digital Cinema/ACDC content 201 and a DC decryption key 203. For example, content 201 and key 203 may be received from a service provider, e.g., a studio/post-processing house that generated the DC/customized ACDC content. The projector 202 may include an ACDC processing module 204 having an extraction module 209, a local decryption module 211, an AC algorithm module 213, a controller 215 and an ACDC decryption key 219, all of which are configured to process at least any forensic data in content 201 and described further below with reference to FIG. 4.

The projection device 202 may comprise, e.g., a digital projector which includes a database 217 operably connected to at least the security decryption module 205 and the ACDC processing module 204 (e.g., at controller 215). The database 217 includes stored local data, e.g., the projector's internal location/security identification settings, etc. For example, the projector database 217 may include ‘real-time’ information regarding dates/times of showing, a screen/theater number or code, etc. pertinent to that particular projection device and its location, perhaps using global positioning system (GPS) coordinates.

With reference to FIG. 4, Digital Cinema content and a corresponding DC decryption key is input to a projector (steps 401, 402) and a security management procedure is performed (step 403) comprising decryption and verification of location and time of the input DC content. At step 403, real-time information from the projector's local database may be utilized (step 404), thus the location and time verification may include and incorporate real-time information of a particular projection device (e.g., actual time/date of each movie showing). Processing of the input DC content (step 405) is performed, which includes incorporating real-time projection device information in hidden form according to one aspect of the present principles, and additional projector processing steps (steps 409, 411, 413 and 415) described further below.

In steps 409 and 411, forensic content (e.g., sub-titles, closed caption stream data, etc.) may be extracted and decrypted. As discussed above, the forensic content may be provided on a datapath such as an alpha channel. The decryption is performed with an ACDC decryption key 408, which may be provided by a forensic content service provider.

In step 413, the real-time information from database 404 may be incorporated into the ACDC content and the resultant ACDC content having real-time information may be added to the DC content (step 415). Preferably a projection device provided in a system according to an aspect of the present principles includes capabilities/algorithms for rendering the ACDC content unique to the movie showing, theater, screen, city, etc. That is, projector information (from database 404) may be input at step 413 to incorporate real-time projection device information into the forensic content.

In step 417, the main DC image content with incorporated and unique ACDC forensic content is output for display. During, e.g., display on a theater screen, the forensic content is virtually undetectable to a viewing audience so as to not negatively affect or interfere with the substantive movie image content, yet is immediately captured by any recording device (e.g., camcorder) that may record the images. On a pirated copy, the incorporated forensic data according to an aspect of the present principles is immediately detectable to an observer and detailed information about the movie (e.g., theater location, theater screen number, date and time where/when the movie was illegally recorded) may be obtained simply by, e.g., viewing the movie without requiring costly and complicated forensic recovery and data analysis procedures. Advantageously, action could be taken against particular theaters immediately, avoiding days or weeks of delay and further piracy.

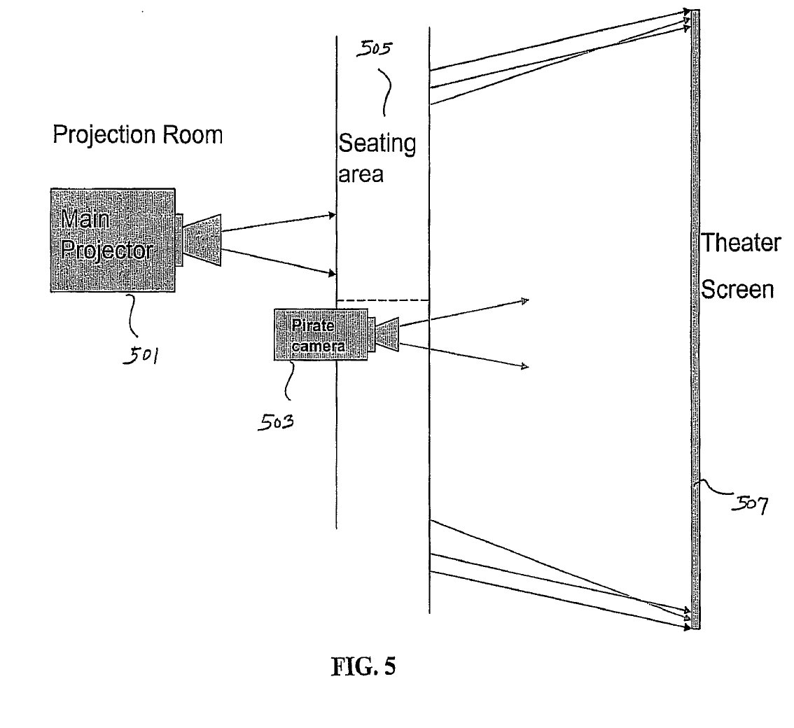

FIG. 5 depicts an exemplary theater and projection system setup for illustrative purposes including a projector 501 projecting movie content onto a theater screen 507 and a pirate camera 503 located in a seating area 505, recording the images from screen 507.

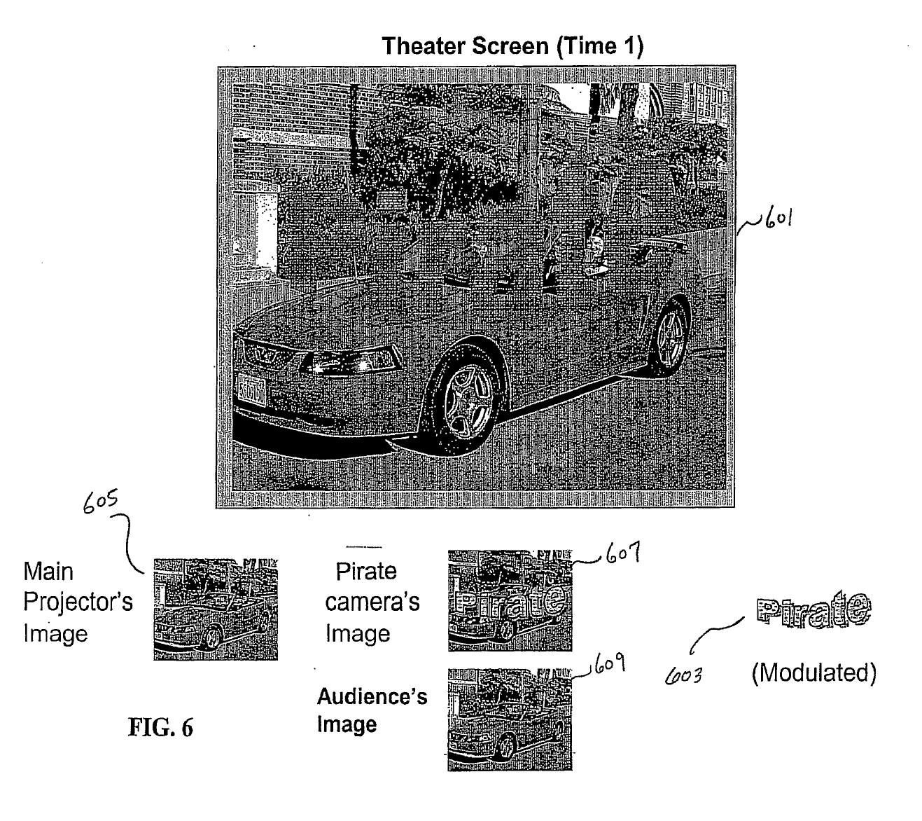

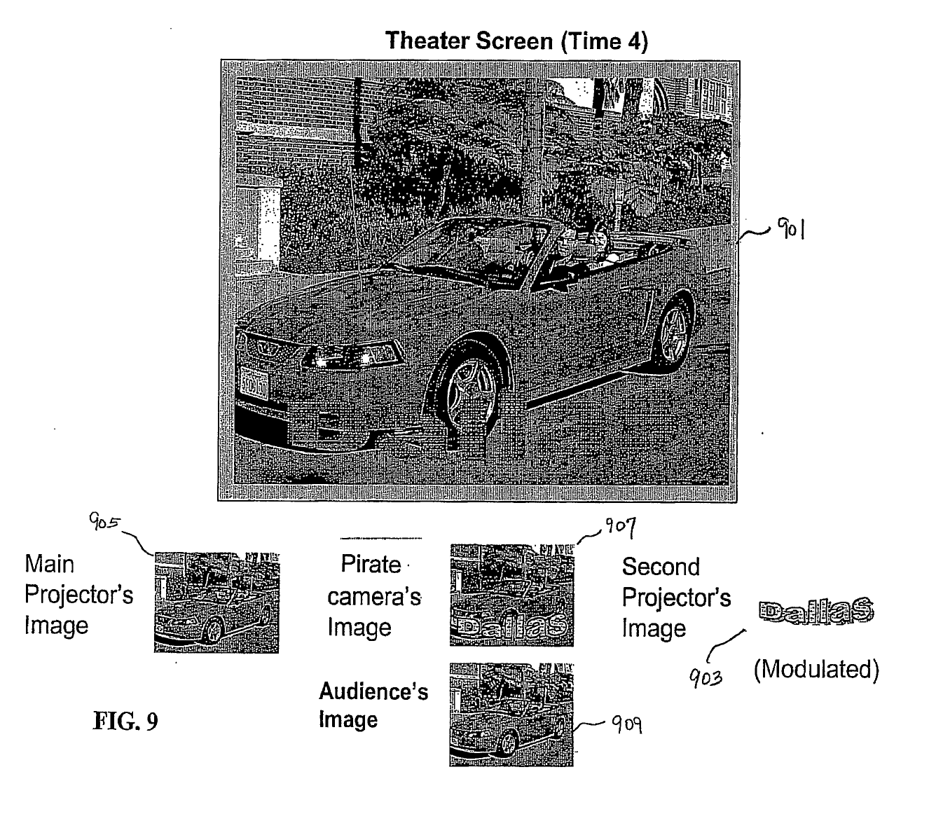

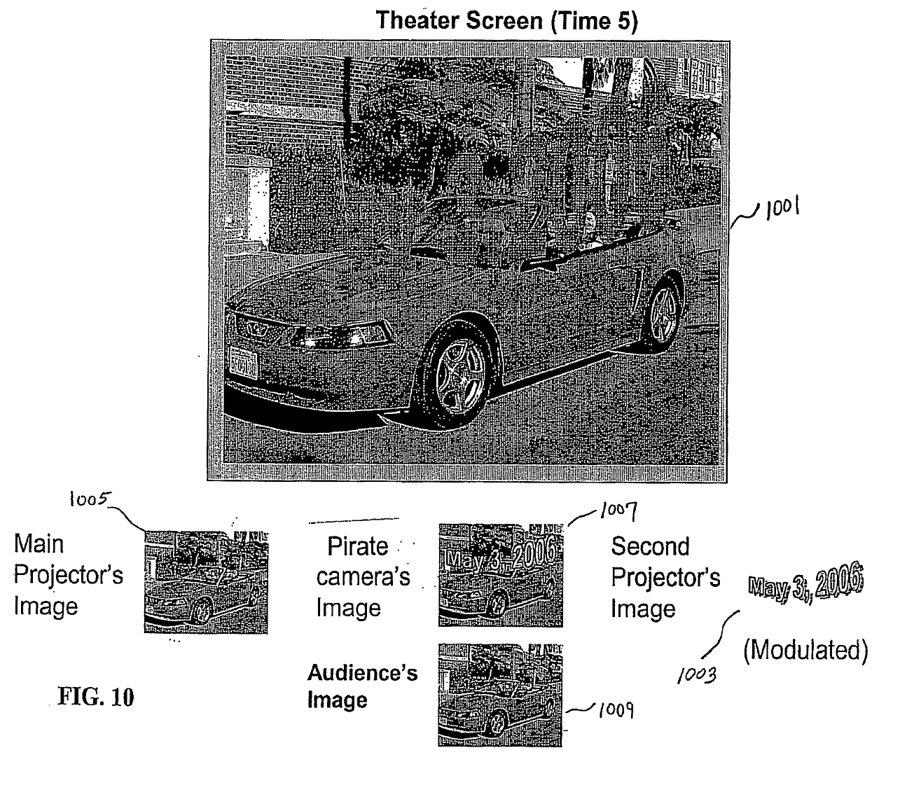

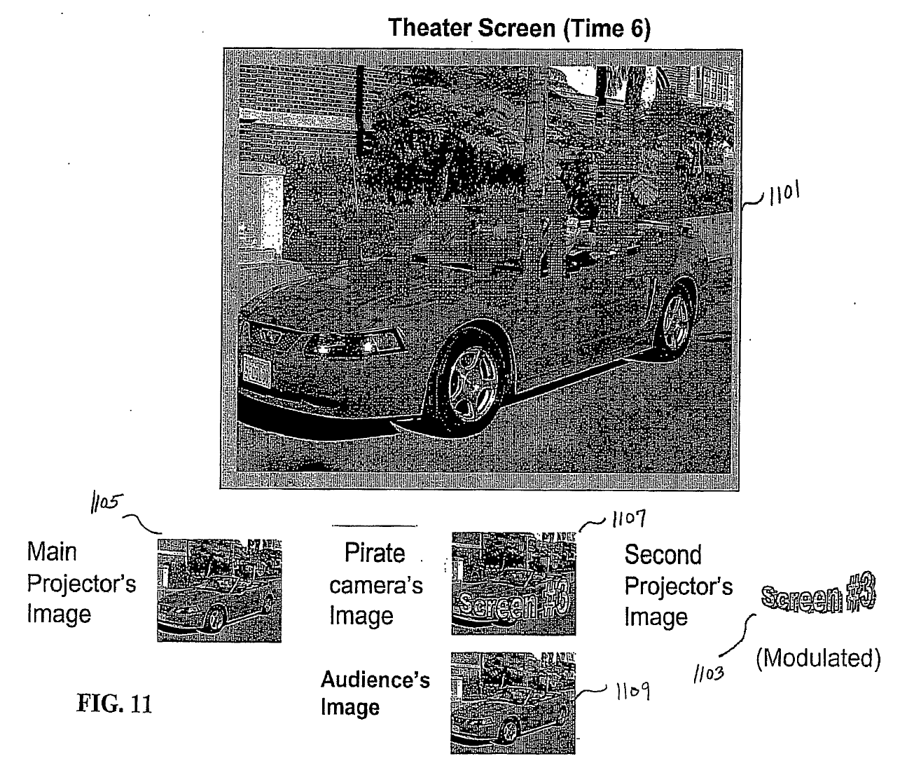

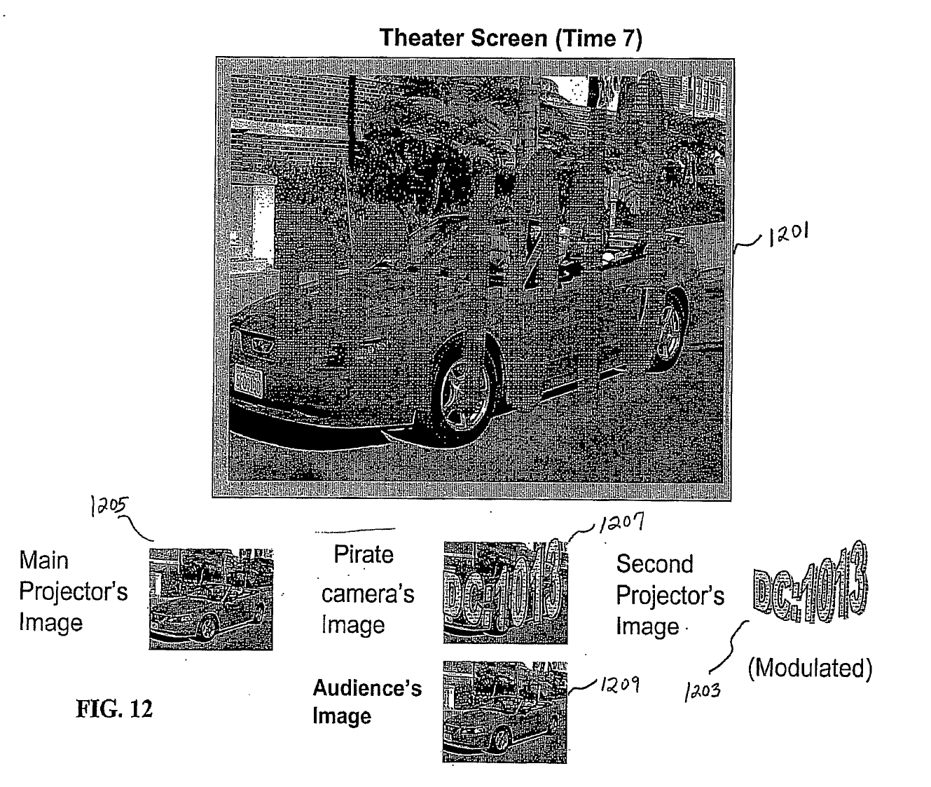

FIGS. 6-12 illustrate exemplary depictions of images 601, 701, 801, 901, 1001, 1101, 1201 with added ACDC content 603, 703, 803, 903, 1003, 1103, 1203. FIGS. 6-12 comprise a series of exemplary scenes with incorporated forensic content in the form of text to illustrate the general effect of a system according to one aspect of the present invention and how over time, added forensic content can be caused to change, e.g., in type, size and shape, etc. to deliver and convey complete, comprehensive and up-to-date information concerning the movie's show time, projector ID, etc. The forensic content could appear subtle or very pronounced in a pirate copy and be located anywhere on an image, yet in all instances is virtually undetectable and obtrusive to the actual movie content in authorized movie copies.

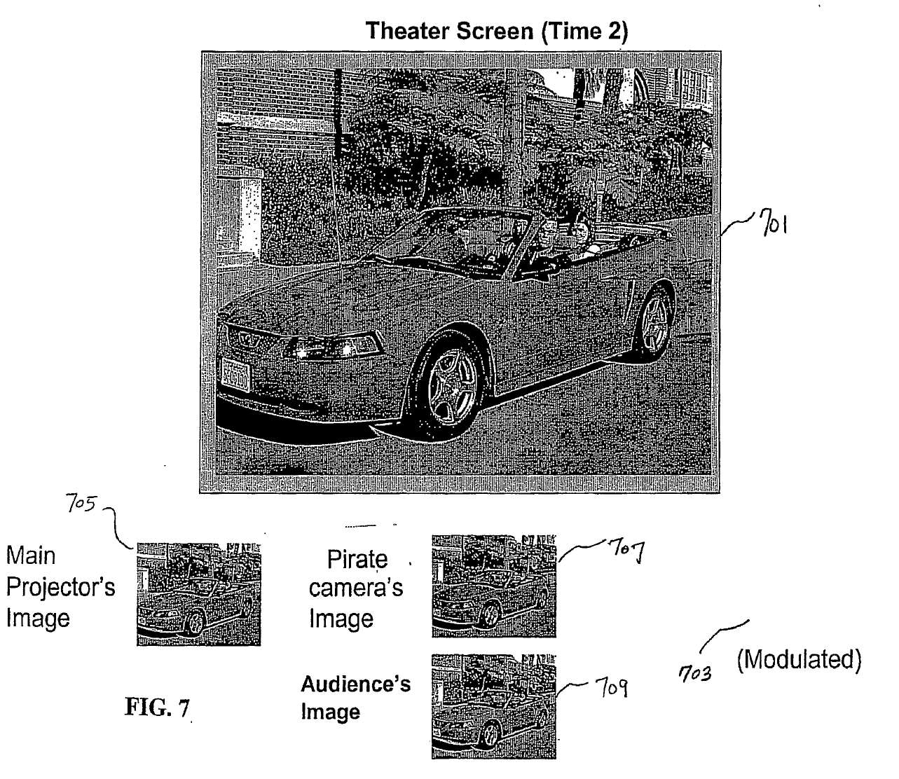

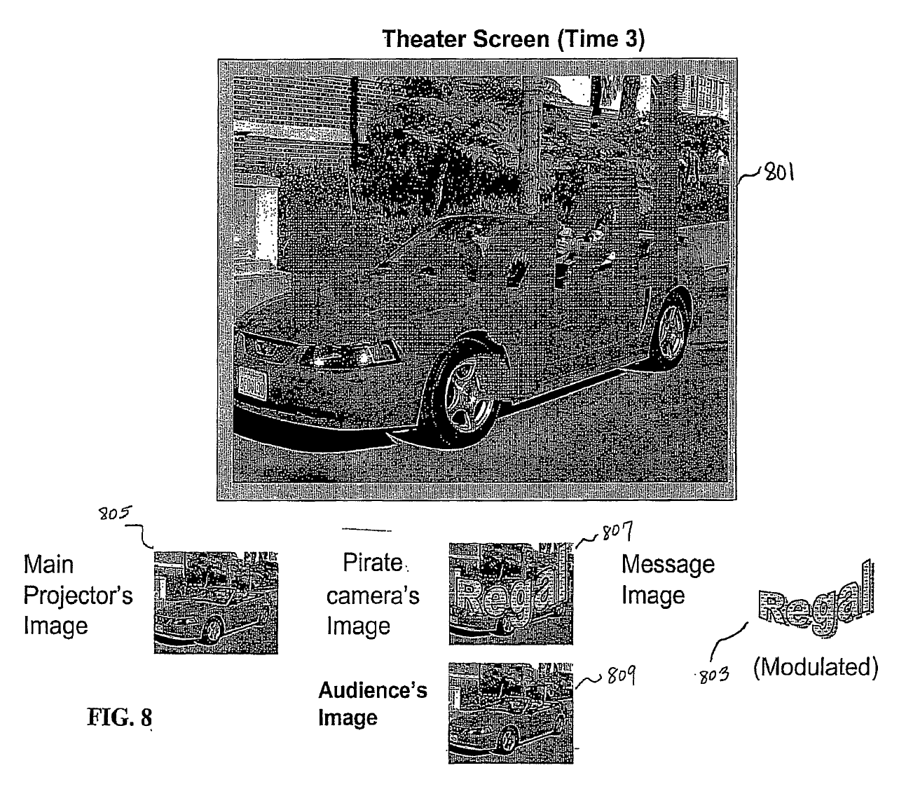

For example, in FIGS. 6 and 8-12, ACDC content in the form of a text message 603, 803, 903, 1003, 1103, 1203 has been added to each image 601, 801, 901, 1001, 1101, 1201, respectively. The text message may be rendered in ‘hidden’ form, e.g., projected via IR/frame/multi-primary modulation so as to be undetectable to the human eye yet capturable by a sampling system; thus, the ACDC content is not visible either on the main projector's images 605, 805, 905, 1005, 1105, 1205 or images seen by the audience 609, 809, 909, 1009, 1109, 1209; however, the ACDC content clearly appears on images captured by a pirate camera 607, 807, 907, 1007, 1107, 1207. FIG. 7 illustrates image 701 taken at a different time, wherein ACDC content 703 is blank. It is noted that in a series of images ACDC may alternately be applied and withheld from images at various times according to one aspect of the present principles. FIGS. 8-12 illustrate ACDC content comprising text data conveying various types of information (e.g., location, date, screen number, etc.) projected in images at different times (e.g., Time 1, Time 2, etc.) during a movie. Preferably, each time a movie is shown, the ACDC text data is altered to reflect the relevant time/date of each actual showing. Over a period of time, complete movie identification information may be conveyed in this manner, which is preferably visible in a pirate copy.

Any scene or series of scenes may be chosen to be modified to add forensic ACDC content. Preferably, incorporated ACDC content includes real-time local information from, e.g., the individual projection devices used to display each particular movie.

To generate letters, words, etc. for a forensic ACDC message, any anti-camcorder technique may be used which preferably provides sufficient pixel accuracy. Exemplary ACDC content may comprise any letters, words, symbols, etc. for a message, which can further be caused to fade in and out, flash, change color, move around on the screen, be very subtle, bold and pronounced, cryptic, etc. ACDC content incorporated according to one aspect of the present principles advantageously conveys valuable forensic data without interfering with the substantive movie content in authorized copies, yet is clearly visible in pirated copies. Namely, forensic information is incorporated without having a negative or noticeable effect on the quality of the movie presentation to viewers/audiences.

Visible ACDC content (e.g., ACDC content fully visible to an audience in both authorized and pirated copies, yet configured to be unobtrusive) encoding forensic information could also be incorporated in an image having ‘hidden’ ACDC content (e.g., content visible only to a sampling system) according to an aspect of the present principles. For example, to thwart editing, such visible markings are preferably incorporated in image area(s) other than where any hidden ACDC markings are placed. This ensures that at least some forensic markings, whether hidden or visible, will likely survive any editing done in a pirated video.

The Digital Cinema Initiative (DCI) specification requires that before a movie can play, it must pass Digital Rights Management which requires each movie to ‘know’ e.g., where it is playing (“Authorized auditorium”), when it is playing (“Engagement Playout Window,” which is a time/data window), what device it is playing on (“Security Manager authenticates equipment prior to key delivery,”) and what specific files are playing (“Security Manager checks and logs movie against the Composition Play List.”) Using ACDC algorithms according to one aspect of the present principles, all of these parameters may be provided in an unobtrusive manner in authorized copies, e.g., as text inserted in selected scenes in a movie.

Moreover, special showings (e.g., such as screenings) could be rendered to include ACDC content comprising e.g., text written directly on the screen to indicate/define the specific circumstances of the showing, according to another aspect of the present principles.

Although the embodiment which incorporates the teachings of the present invention has been shown and described in detail herein, those skilled in the art can readily devise many other varied embodiments that still incorporate these teachings. Having described preferred embodiments for a system and method for generating and incorporating forensic information into digital cinema content for anti-piracy purposes (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A method for providing forensic information for digital cinema content comprising the steps of:
generating (303) forensic content configured for display with said digital cinema content, the forensic content comprising text data composed at the time of display of said digital cinema content;
receiving said digital cinema content;
incorporating said forensic data into said digital cinema content in a manner to be visible only when viewing a non-authorized recording of said digital cinema content; and
displaying said digital cinema content.

2. The method of claim 1, wherein the step of generating further comprises the steps of:
analyzing the digital cinema content for determining desired characteristics of the forensic content;
encrypting the forensic content; and
formatting the encrypted forensic content as an auxiliary data stream.

3. The method of claim 2, further comprising the step of processing said auxiliary data stream for output with said digital cinema content.

4. The method of claim 2, wherein the encrypted forensic content comprises at least one of a sub-title and a closed-caption stream.

5. The method of claim 2, wherein the step of incorporating said text data into said forensic content further comprises the steps of:
verifying the digital cinema and forensic content using information from a projection device configured to process and display at least said digital cinema content;
extracting and decrypting the encrypted forensic content; and
incorporating the text data into the decrypted forensic content.

6. The method of claim 1, wherein said forensic content comprises said text data indicating at least one of an actual time, date and location pertaining to each showing of said digital cinema and forensic content.

7. The method of claim 1, wherein said forensic content comprises said text data encoded to indicate at least one of time, date and location information pertaining to each showing of said digital cinema and forensic content.

8. The method of claim 7, further comprising the step of generating a forensic content decryption key corresponding to said forensic content.

9. A system for processing forensic information for digital cinema content comprising:
a projection device configured to process and display at least
digital cinema content and forensic content, wherein said forensic content comprises text data configured to be perceptible only when viewing an un-authorized recording of said digital cinema content, said text data being indicative of conditions of an authorized display of said digital cinema content.

10. The system of claim 9 wherein said projection device further comprises:
a security decryption module for decrypting and verifying the digital cinema and forensic content;
an extraction module configured to extract the forensic content;
a local decryption module for decrypting the forensic content;
a controller for incorporating said text data into the forensic content; and
an algorithm module for incorporating the forensic content into the digital cinema content.

11. The system of claim 9, wherein the projection device includes a database including information indicative of the time and location of said projection device.

12. The system of claim 9, wherein said forensic content comprises text data indicating at least one of a location, date, time, screen number and identification of the projection device pertaining to each showing of the digital cinema content.

13. The system of claim 9, wherein said forensic content comprises text data encoded to indicate at least one of time, date and location information pertaining to each showing of the digital cinema content.

14. The system of claim 11, wherein said security decryption module incorporates information from said database for incorporation in said digital cinema content.

15. The system of claim 9, wherein said projection device further includes a processor configured to incorporate the forensic content into the digital cinema content.

16. A system for generating and processing forensic information for digital cinema content comprising:
an analyzer module configured to analyze digital cinema content for generating forensic content, the forensic content comprising text data indicative of a non-authorized display of said digital cinema content, said forensic content configured to describe the conditions of an authorized display of said digital cinema content and containing information pertaining to each authorized showing of the digital cinema content.

17. The system of claim 16 wherein the digital cinema content and the forensic content are configured to be displayed by a projection device configured to process and display at least the digital cinema content and said forensic content, said projection device further comprising:
a security decryption module for decrypting and verifying the digital cinema and forensic content; and
a controller for incorporating said text data into the customized forensic content.

18. The system of claim 16, wherein said forensic content comprises the text data indicating at least one of a location, date, time, screen number and identification of the projection device during each showing of the digital cinema content.

19. The system of claim 17, wherein said projection device further includes a processor configured to incorporate the text data into the customized forensic content in a form such that said text data are visible when viewing an un-authorized recording of said digital cinema content.

20. The system of claim 17, wherein said forensic content comprises text data encoded to indicate at least one of time, date and location information pertaining to each showing of the digital cinema content.
